(19) United States
(12) Patent Application Publication
(10) Pub. No.: US 2011/0083081 A1
(43) Pub. Date: Apr. 7, 2011

(54) SYSTEMS AND METHODS FOR ALLOWING A USER TO CONTROL THEIR COMPUTING ENVIRONMENT WITHIN A VIRTUAL COMPUTING ENVIRONMENT

(76) Inventors: Joe Jaudon, Sedalia, CO (US); David Lowrey, Denver, CO (US); Adam Williams, Aurora, CO (US)

(21) Appl. No.: 12/575,391

(22) Filed: Oct. 7, 2009

(51) Int. Cl. G06F 21/00; G06F 3/01

(52) U.S. Cl. 715/743; 726/1

(57) ABSTRACT

The present invention provides systems and methods for allowing a user to control their computing environment within a virtual computing environment. Specifically, various systems and methods as provided by the present invention allow for users to configure their computing environment within a virtual computing environment based on changing locations within a single computing session. Depending on the embodiment, the system and method may be used for sessions provided by an application control environment or a virtual computing environment. Embodiments of the invention allow for user control of the computing environment based on user policy rules. These user policy rules may be used to implement access control on users of the computing session.

### TECHNICAL FIELD

The present invention relates generally to desktop and application virtualization, and more particularly, some embodiments relate to dynamically manipulating and/or reconfiguring a user interface within a virtual computing environment.

### DESCRIPTION OF THE RELATED ART

Virtual computing is a common computing model where operating systems, desktop, and applications operate based on an abstraction of computing resources. Virtual machines, desktop virtualization and application virtualization are three common forms of virtual computing. Virtual computing machines (or simply virtual machines) are PC hardware emulated by software (commonly referred to as virtual machine software) running on a physical machine. The emulated PC hardware creates a distinct and separate “virtual machine” within the physical machine, which operates on top of and concurrently with the existing physical machine. This allows a given physical machine to host one or more virtual machines, each having its own operating system, desktop, and applications. The software running within the virtual machine is separate and distinct from the software running on the physical machine.

Desktop virtualization is another form of virtual computing which relates to remote desktop computing. In remote desktop computing, a client application or operating system feature enables an application (graphical or otherwise) or a desktop to run remotely on a remote computing machine (e.g., server). Desktop virtualization relates to remote desktop computing because desktop virtualization involves the decoupling of a user's physical machine from the software providing the desktop and related applications (e.g., server software). In one example of desktop virtualization, a desktop session operating on a remote computing device (e.g., server) or operating within a virtual machine running on a remote computing device is delivered to a client local machine (e.g., thick-client or thin-client) via a network connection. The resulting desktop (often referred to as a remote or virtual desktop) comprises a graphical user interface environment with windows, icons, menus and an input cursor (e.g. mouse pointer), all of which can be accessed by a user through the local machine as if the desktop session were operating locally.

Similarly, application virtualization is another form of virtual computing which relates to remote desktop computing where applications are allowed to function without being installed and configured directly on the terminal or computing device at the point of user access. Like virtualized desktops, virtualized applications are served up and accessed by users from the network via remote computing device (e.g., server) that hosts a platform such as Citrix®, Microsoft® Terminal Services, and VMWare®. However, unlike virtualized desktops, only the application is served to the client, and not the entire desktop.

Common examples of virtual desktop and virtual application platforms include virtual desktop infrastructures (e.g. VMWare® View, Microsoft® Hyper-V, Citrix® XenDesktop™), (stateful) thin-client services (e.g. Microsoft® Terminal Services, Citrix® XenApp®), and stateless thin-client services (e.g. Sun Microsystem's® Sun Ray™ Software).

Virtual desktop infrastructures (VDIs) are server-centric computing models where the operating system desktop (e.g. Microsoft® Windows®, GNOME, etc.) is running or hosted remotely on a full-fledge physical computer acting as a server or on a virtual machine (a software implementation of a computer whereby a self-contained operating environment within virtualized computer is provided) running on a server. Upon user login, the desktop is delivered to a client computer via a network connection such that a user is able to interact with the desktop through the client computer as if the desktop were being run/hosted locally at the client computer. Virtual desktop infrastructures are described as a “One-to-Many” design, where one specific type of VDI platform and associated virtual desktop can be served up to many types of computing devices that run a “client agent” for the VDI platform.

Thin-client services, such as Microsoft® Terminal Services and Citrix® XenApp®, are general client-server architectures where a PC, laptop, or other computer device, serving as thin-client depends primarily on a central server or host computer for the bulk of its processing activities. Generally, the thin-client computer merely displays graphics provided by the server and accepts inputs from the user. Like VDI platforms, thin-client services usually leverage client side agents to display related virtual desktops to PC's, laptops and other computing devices having the client agent. Thin-client services are also described as a “One-to-Many” design.

FIG. 1 (prior art) is a diagram illustrating a conventional “One-to-Many” system where the virtual platform, desktop, or application resides and runs on a host computer 10, such as a server. Various computing devices, such as personal digital assistants (PDAs) 12, PCs 14, laptops 16, thin-terminals 18, and smart phones 20 (e.g. iPhone®, Blackberry®), connect to the host computer 10, which delivers the virtual platform, desktop or application to the computing device over a network connection via various proprietary and non-proprietary network protocols (e.g. HTTP, UDP, ICA).

Some thin-client services are stateless such that they utilize a stateless connectivity between the thin-client and the host computer. The stateless connectivity provides the capability for portable sessions, where a user can start a session at one thin-client, and then move to another thin-client where the original session can be resumed. In other words, the thin-client sessions are independent of the connection and can resume display of sessions that were previously disconnected. A well-known example of this architecture is the Sun Microsystems® Sun Ray™ Software, which not only provides a stateless thin-client solution but also supports delivery of a different virtual platforms, desktops, and applications. Through Sun Ray™ Software, different virtual platforms, desktops and applications are virtually delivered to Sun Ray™ compatible thin-client terminals. Stateless thin-client services are described as a “Many-to-One” design, where multiple virtual platforms and associated virtual desktops (e.g. VDI, Citrix, Microsoft Terminal Services, etc.) can be served up to one specific type of compatible computing device (e.g. Sun Ray™ compatible device.) Other types of thin-client infrastructure devices can include Wyse® Thin Clients, HP® Thin Clients, etc. Generally, stateless thin-client services can be described as a “Many-to-One” design, where multiple virtual platforms and associated virtual desktops (e.g., VDI, Citrix, Microsoft Terminal Services, etc.) can be served up to one specific type of compatible computing device (e.g., Sun Ray™ compatible device).

FIG. 2 (prior art) is a diagram illustrating an example “Many-to-One” system where a variety of the virtual platforms 26 are running on a variety of host computers (28, 30, and 32). Through the thin client compatible device 22, this variety of virtual platforms is deliverable to the thin client compatible device 22. The thin client software communicates to the virtual platforms 26 using various compatible protocols (e.g. RDP, ICA, etc). The thin client device may be controlled through a central management system, including Sun Ray™, using the Appliance Link Protocol (ALP).

Of the above-identified architectures, architectures similar in functionality to the Sun Ray™ thin-client solution allow for the benefit “smooth roaming” or “hot-decking” Citrix, Microsoft, Wyse, etc have a smooth roaming or hot-decking type of functionality to deliver the virtual desktop, application, or platform to the end user through a thin client compatible device. Smooth roaming is defined as the ability for a user to move from one terminal to another terminal and still gain access to the same session. This session may be a remote session to a remote machine or a virtual session to a virtual desktop or virtual application. Unfortunately, when smooth roaming between terminals (e.g., different computing devices), the user interface within such sessions is static and does not change in response to a change in location of access. Because different computing devices may be in different locations, the user interface may need to be reconfigured “on the fly” based on policy or access control concerns. For example, an application could be either hidden or maximized depending on the location of the user within the same logon-session.

### BRIEF SUMMARY OF EMBODIMENTS OF THE INVENTION

The present invention provides systems and methods for allowing a user to control their computing environment within a virtual computing environment. Specifically, various systems and methods as provided by the present invention allow for users to configure their computing environment within a virtual computing environment based on changing locations within a single computing session. Depending on the embodiment, the system/method may be used for sessions provided by an application control environment or a virtual computing environment. Embodiments of the invention allow for user control of the computing environment based on user policy rules. These user policy rules may be used to implement access control on users of the computing session.

In one embodiment, a method for allowing a user to control a computing environment within a computing session comprises: detecting a request from the user to configure an aspect of the computing environment; determining a computing session attribute; selecting a user policy rule based on the computing session attribute, wherein the user policy rule defines an allowed level of control of the computing environment by the user; and applying the user policy rule to the computing environment by allowing or preventing the user from controlling the computing environment based on the user policy rule. In some embodiments, the computing session is provided by a virtual computing platform (e.g., server running virtual computing software). Additionally, the user policy rule may be selected from a datastore, such as a database.

Depending on the embodiment, the computing session attribute may include a user credential, a terminal type (device type), terminal physical location (device physical location), terminal network location (device network location), and terminal connection type (device connection type). A terminal is a thin client computing device. The user policy rule may be based on a user interface action, a user credential, or a user interface designation.

In certain embodiments, the user policy rule is applied to the computing environment by allowing or preventing the user from interacting with a user interface of the computing environment. In some such embodiments, allowing or preventing the user from interacting with the user interface may further involve allowing the user to or preventing the user from executing a user interface action.

In some embodiments, the user interface action may be one or more of the following creating, hiding, closing, minimizing, maximizing, normalizing, hiding, or moving a graphical window; reordering two or more graphical windows; keyboard input; creating, deleting, or renaming a file; creating, deleting, renaming, or modifying a directory; changing a file attribute; changing a directory attribute; and executing, terminating, suspending, or deleting a process. In other embodiments, the user credential may include a user identity and/or a user group. Within additional embodiments, in the user interface designation may identify a specific user interface element, a file or a directory.

According to further embodiments, various operations described above are implemented to allow computer implementation of the invention. For example, some embodiments provide for a computer program product comprising a computer usable medium having computer program code embodied therein for controlling a user interface in a computing environment in accordance with aspects of the invention as described herein.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 (prior art) is a diagram illustrating an example one-to-many system utilizing a virtual platform, desktop or application.

FIG. 2 (prior art) is a diagram illustrating an example one-to-many system utilizing the thin client device.

FIG. 3 illustrates a method allowing a user to or restricting a user from controlling their computing environment in accordance with one embodiment of the invention.

FIG. 4 illustrates an example system and method for allowing a user to or restricting a user from controlling their computing environment within a computing session in accordance with one embodiment of the invention.

FIG. 5 illustrates a computing session screen to which an embodiment of the invention could be applied.

FIG. 6 illustrates an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

The present invention provides systems and methods for allowing a user to control their computing environment within a virtual computing environment. Specifically, various systems and methods as provided by the present invention allow for users to configure their computing environment within a virtual computing environment based on changing locations within a single computing session. Depending on the embodiment, the system and method may be used for sessions provided by an application control environment or a virtual computing environment. Embodiments of the invention allow for user control of the computing environment based on user policy rules. These user policy rules may be employed to implement access control on users of the computing session.

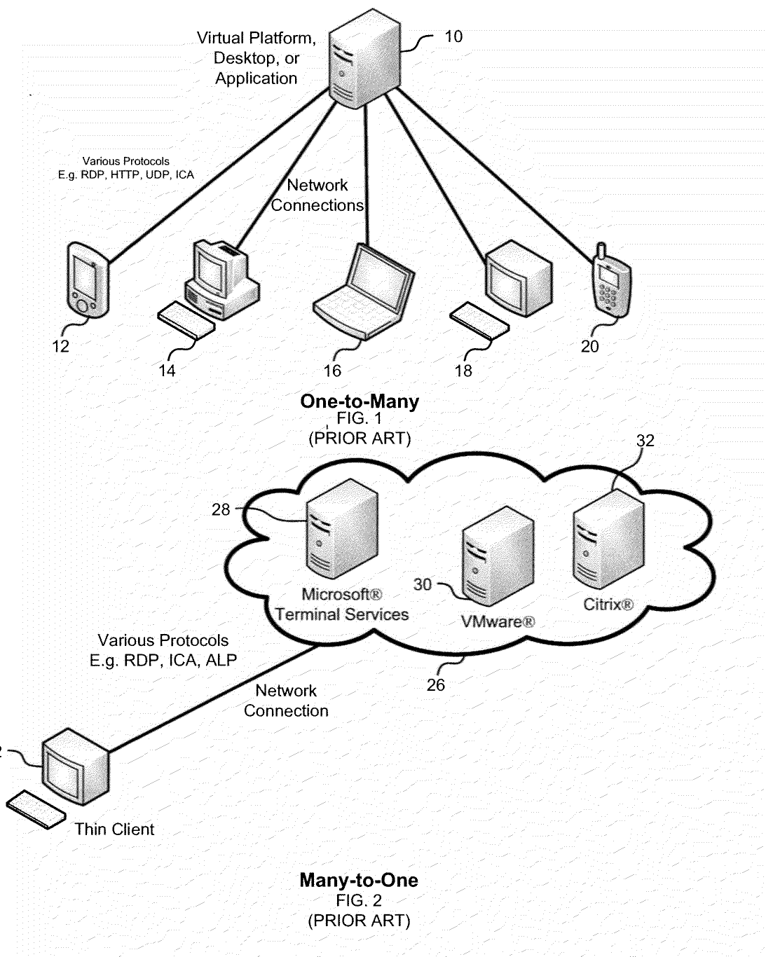

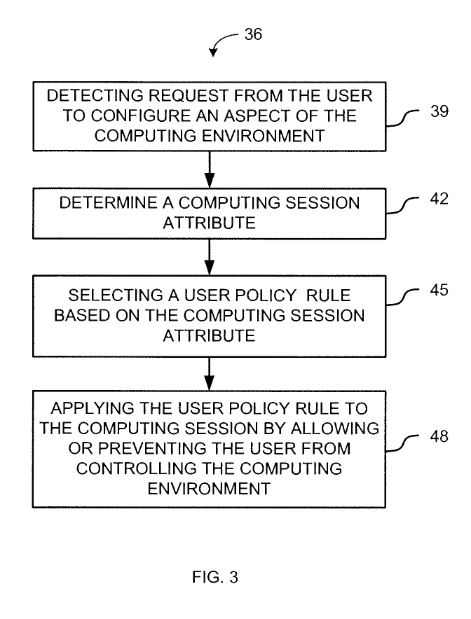

FIGS. 1 and 2 (prior art), as previously described, illustrate conventional systems in which embodiments of the present invention can be implemented. FIG. 3 illustrates an example method 36 implementing one such embodiment. Method 36 initiates upon detection 39 of a request from the user to configure an aspect of the computing environment. As noted earlier, the applicable computing environment can be created and presented in a number of methods, including through a computing session that is provided from a local or remote computing source. Additionally, the request to configure may be through a server operating a connection broker or connection management software, or directly to a server providing the computing session.

Next, the method 36 determines attributes of the computing session at operation 42 in order to determine which computing session attributes, if any, are applicable to the request to the computing environment. As previously noted, the computing session attribute may include, but is not limited to, the credentials of the user accessing the computing session, the type of terminal (e.g., thick-client, thin-client, laptop, PDA) accessing the computing session, the physical location of the terminal accessing the computing session, the network location of the terminal accessing the computing session, and the connection type between the terminal accessing the computing session and the server that provides the computing session. For example, a specific user policy rule A may be applicable only to terminals using a wireless network connection to connect to the server, while a specific user policy rule B may be applicable only to terminals using a wired network connection. Other attributes may use a specific physical location within a building or amongst office sites in different geographic regions. Such user policy rules could be useful, for example, when a user is moving from one terminal to the next using a roaming session.

Using the computing session attribute determined in operation 42, the method continues by selecting a user policy rule from a datastore at operation 45. The datastore from which the user policy rule is selected may be a database, SQL database, LDAP database, flat file, flat file database, or other storage mechanism, of which resides at the server or another remote computing device.

Upon selection of a user policy rule based on the computing session attribute, the method 36 commences application of the user policy rule to the computing session at operation 48. In some embodiments, the rule is applied by intercepting a user interface action made within the computing session, and either allowing or restricting the user interface action based on the user policy rule. For example, the user interface action may be the user resizing or moving a window within the computing session. In another example, a user at the terminal may send a command to close a specific graphical window within the computing session, however a specific user policy rule may prohibit such an action and block the command from ever reaching the computing session provider (e.g., computing session server) when the terminal is at location A (but not when the terminal is at location B).

In other embodiments, the application of the user interface rule on the computing session may be facilitated by creating a configuration setting within the computing session that determines the level of control the user has within the computing session. Typically, such an embodiment would create the configuration at the beginning of the login process into a computing session.

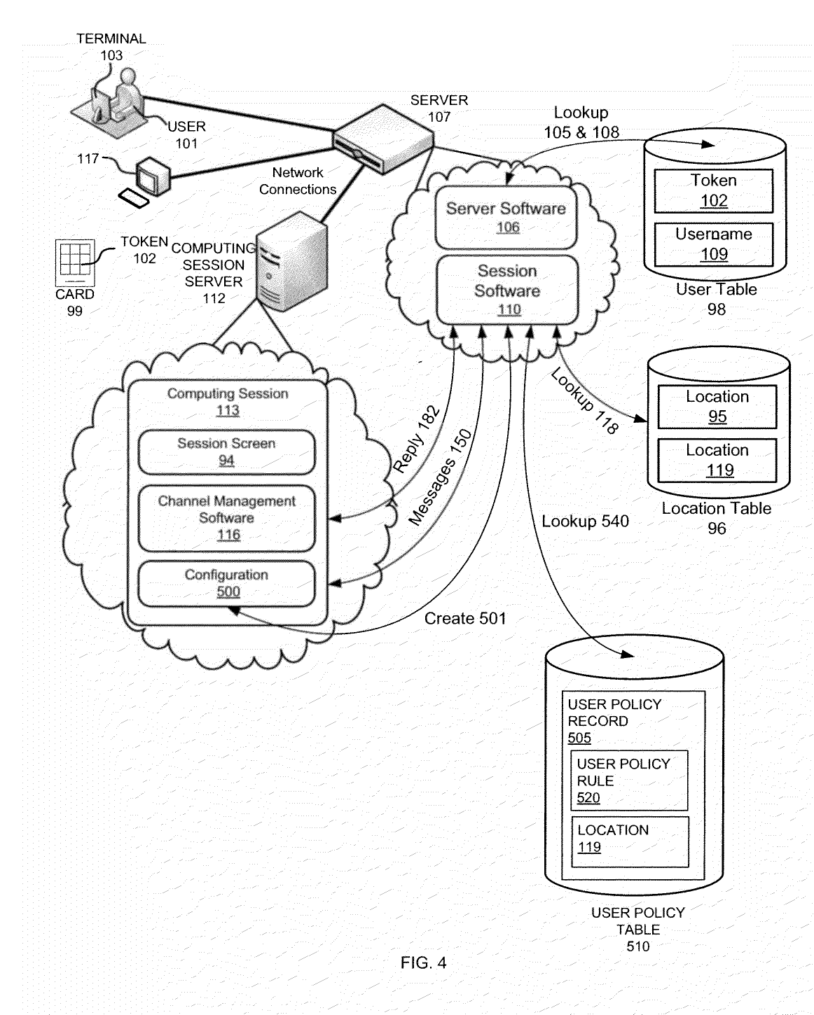

FIG. 4 illustrates an example system and method for controlling a user interface in a computing environment in accordance with one embodiment of the invention. Specifically, this example system and method illustrates how an embodiment of the current invention can be used in conjunction with session roaming capabilities. This example begins with user 101 using an authentication token 102 into terminal 103. Terminal 103, in turn, sends an insert signal and the authentication token 102 in server software 106 hosted on server 107. Server software 106 performs a table lookup 108 on user table 98 whereby the authentication token 102 is uniquely associated with a user identifier, in this case a username 109. Server software 106 then executes a session software 110, which initiates a channel connection with a computing session server 112, passing the earlier received username 109 as a parameter. It should be noted that any of the tables described herein can be stored on one or more datastores (e.g., one or more databases).

Server 112 then creates a new computing session 113 and binds it to username 109 if computing session 113 does not already exist. Within the computing session 113 exists a computing environment (e.g., mouse input, keyboard input and screen output) through which the user interacts with the computing session 113. By binding the computing session 113 to username 109, server 112 allows one and only one computing session 113 for username 109. Hence, if a computing session 113 already exists and is bound to username 109, no binding is required. However, if computing session 113 does not exist, server 112 creates computing session 113 and binds it to username 109.

Session software 110 then performs a table lookup 97 on location table 96, where terminal 103 is uniquely associated with a location 95. The memory variable location of session software 110 is set to this location 95 because of the table lookup 97. Computing session 113 continues by executing channel management software 116. The channel software 116 is implemented and initiated in such a manner as to facilitate bi-directional messages to and from session software 110. Through these bi-direction messages, session software 110 is capable of such actions as controlling, manipulating, and reconfiguring a user interface within computing session 113. Within some embodiments, the session software 110 is able to allow or prevent user interaction with user interface of computing session 113. Generally, the user interface is displayed through the session screen 94.

Assume now that user 101 moves to terminal 117 after removing card 99 containing token 102 from terminal 103. User 101 now inserts card 99 containing token 102 into terminal 117. Terminal 117 sends an insert signal and user token 102 to server software 106 hosted on server 107. Server software 106 performs a table lookup 105, which converts user token 102 into username 109. Server software 106 then connects to session software 110. Session software 110, in turn, initiates a channel connection with a computing session server 112 passing username 109 as a parameter.

Computing session server 112 connects to computing session 113 for username 109 based on the binding previously noted. Session software 110 performs table lookup 118 on location table 96, whereby terminal 117 is uniquely associated with a location 119. The memory variable location of session software 110 is compared to location 119. If location 94, which was set during user 101's previous login, is equal to location 119, processing of computing session 113 continues as normal. However, if location 94 and 119 are not equal, session software 110 performs a table lookup 540 on user policy table 510 to search for any applicable user policy records that are applicable to the current computing session. For the case illustrated in FIG. 4, user policy record 505 is located since is associated with location 119. User policy record 505 contains one or more user policy rules (e.g., 520) that may contain one or more allowances or restrictions that determine how the user 101 is allowed to control the computing environment within the computing session 113. For example, the user policy record 505 may define a restriction in user policy rule 520 such that when the user 101 accesses computing session 113 from location 119, the user 101 is restricted from closing any windows or minimizing any windows. Optionally, the user policy record 505 may be stored and locatable based other attributes of the computing session 113. Examples of such attributes include, but are in no way limited to, the terminal type accessing the computing session 113, the user's credentials, the user's identity, the user's user group, or the connection type between the server 107 and the terminal 103.

Depending on the embodiment, the allowance or restriction of the user 101 to control the computing environment may be implemented through a “filter” system (not shown) within the session software 101, which determines which user interface actions from user 101 to pass on to the computing session 113. In the illustrated embodiment, session software 110 uses the user policy rule 520 from the user policy record 505 to create a configuration 500 on the computing session 113 that defines the user's control allowances and restrictions within the session 113.

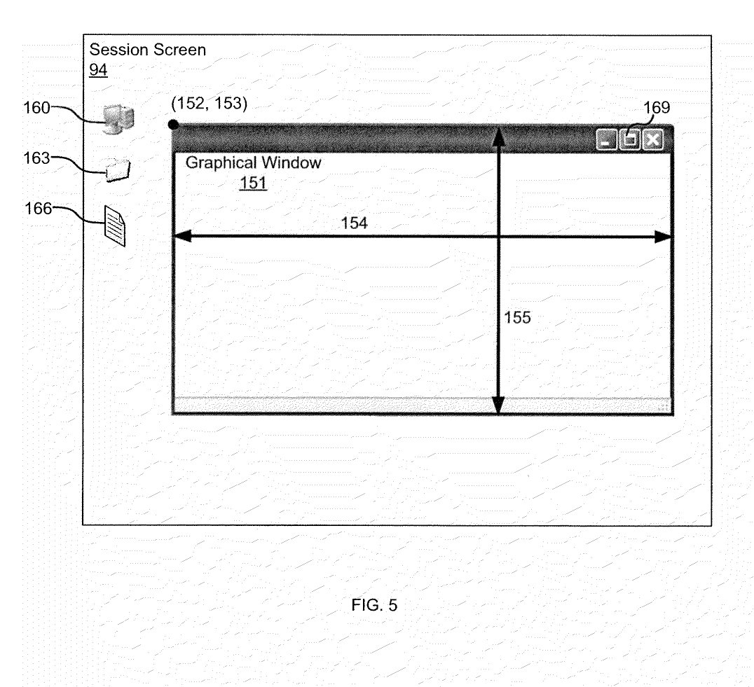

FIG. 5 illustrates a computing session screen to which an embodiment of the invention could be applied. Specifically, FIG. 5 depicts the earlier identified desktop screen 94, which is delivered to the terminal screen once a computing session is established and operating. The illustrated session screen 94 displays an icon 160, a graphical representation of a directory 163, graphical representation of a file 166, a graphical window 151, and buttons 169, all of which could be considered user interface elements under an embodiment of the invention and, as such, can be controlled, reconfigured, and manipulated by the same embodiment. Dimensions 154 and 155 represent examples of user interface attributes of the graphical window 151 that can be allowed or restricted from adjustment by the user in accordance with a user policy rule.

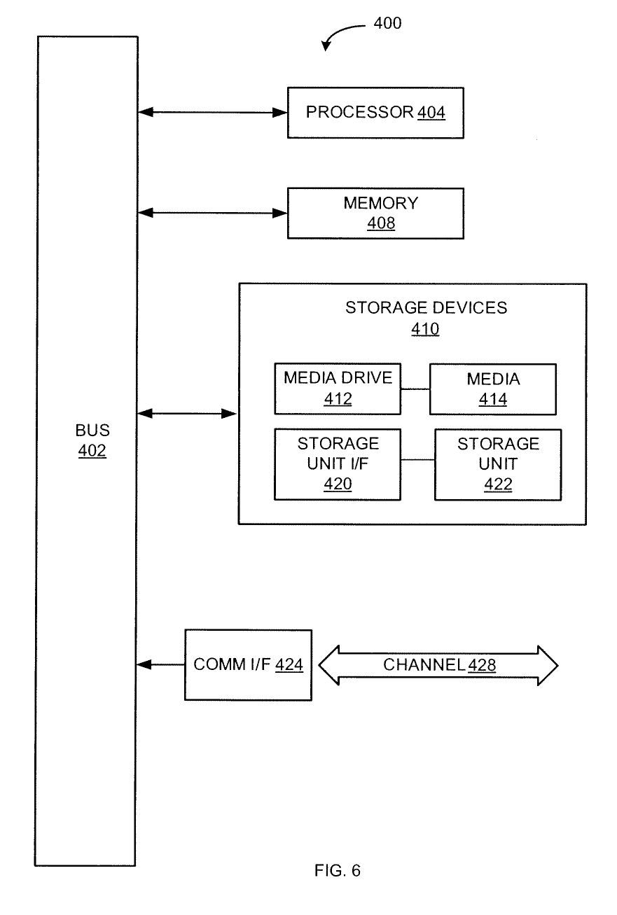

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 6. Various embodiments are described in teens of this example-computing module 400. After reading this description, it will become apparent to a person skilled in the relevant art how to implement the invention using other computing modules or architectures.

Referring now to FIG. 6, computing module 400 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally.

Computing module 400 might also include one or more memory modules, simply referred to herein as main memory 408. For example, preferably random access memory (RAM) or other dynamic memory, might be used for storing information and instructions to be executed by processor 404. Main memory 408 might also be used for storing temporary variables or other intermediate information during execution of instructions to be executed by processor 404. Computing module 400 might likewise include a read only memory (“ROM”) or other static storage device coupled to bus 402 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a floppy disk drive, a magnetic tape drive, an optical disk drive, a CD or DVD drive (R or RW), or other removable or fixed media drive might be provided. Accordingly, storage media 414 might include, for example, a hard disk, a floppy disk, magnetic tape, cartridge, optical disk, a CD or DVD, or other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing module 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory module) and memory slot, a PCMCIA slot and card, and other fixed or removable storage units 422 and interfaces 420 that allow software and data to be transferred from the storage unit 422 to computing module 400.

Computing module 400 might also include a communications interface 424. Communications interface 424 might be used to allow software and data to be transferred between computing module 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 408, storage unit 420, media 414, and signals on channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for allowing a user to control a computing environment within a computing session, comprising:
detecting a request from the user to configure an aspect of the computing environment;
determining a computing session attribute;
selecting a user policy rule based on the computing session attribute, wherein the user policy rule defines an allowed level of control of the computing environment by the user; and
applying the user policy rule to the computing environment by allowing or preventing the user from controlling the computing environment based on the user policy rule.

2. The method of claim 1, wherein the computing session attribute includes a user credential, a terminal type, a terminal physical location, a terminal network location, and a terminal connection type.

3. The method of claim 1, wherein the user policy rule is based on a user interface action, a user credential, or a user interface designation.

4. The method of claim 3, wherein the user interface action is selected from the group consisting of: creating, hiding, closing, minimizing, maximizing, normalizing, hiding, or moving a graphical window; reordering two or more graphical windows; keyboard input; creating, deleting or renaming a file; creating, deleting, renaming, or modifying a directory; changing a file attribute; changing a directory attribute; and executing, terminating, suspending, or deleting a process.

5. The method of claim 3, wherein the user credential includes a user identity and a user group.

6. The method of claim 3, wherein the user interface designation identifies a specific user interface element, a file, or a directory.

7. The method of claim 1, wherein the user policy rule is selected from a datastore.

8. The method of claim 1, wherein applying the user policy rule to the computing environment involves allowing or preventing the user from interacting with a user interface of the computing environment.

9. The method of claim 8, wherein allowing or preventing the user from interacting with the user interface comprises allowing the user to or preventing the user from executing a user interface action.

10. The method of claim 9, wherein the user interface action is selected from the group consisting of: creating, hiding, closing, minimizing, maximizing, normalizing, hiding, or moving a graphical window; reordering two or more graphical windows; keyboard input; creating, deleting or renaming a file; creating, deleting, renaming, or modifying a directory; changing a file attribute; changing a directory attribute; and executing, terminating, suspending, or deleting a process.

11. A computer program product comprising a computer usable medium having computer program code embodied therein for controlling a user interface in a computing environment, comprising:
detecting a request from the user to configure an aspect of the computing environment;
determining a computing session attribute;
selecting a user policy rule based on the computing session attribute, wherein the user policy rule defines an allowed level of control of the computing environment by the user; and
applying the user policy rule to the computing environment by allowing or preventing the user from controlling the computing environment based on the user policy rule.

12. The computer program product of claim 11, wherein the computing session attribute includes a user credential, a terminal type, a terminal physical location, a terminal network location, and a terminal connection type.

13. The computer program product of claim 11, wherein the user policy rule is based on a user interface action, a user credential, or a user interface designation.

14. The computer program product of claim 13, wherein the user interface action is selected from the group consisting of: creating, hiding, closing, minimizing, maximizing, normalizing, hiding, or moving a graphical window; reordering two or more graphical windows; keyboard input; creating, deleting or renaming a file; creating, deleting, renaming, or modifying a directory; changing a file attribute; changing a directory attribute; and executing, terminating, suspending, or deleting a process.

15. The computer program product of claim 13, wherein the user credential includes a user identity and a user group.

16. The computer program product of claim 13, wherein the user interface designation identifies a specific user interface element, a file, or a directory.

17. The computer program product of claim 11, wherein the user policy rule is selected from a datastore.

18. The computer program product of claim 11, wherein applying the user policy rule to the computing environment involves allowing or preventing the user from interacting with a user interface of the computing environment.

19. The computer program product of claim 18, wherein allowing or preventing the user from interacting with the user interface comprises allowing the user to or preventing the user from executing a user interface action.

20. The computer program product of claim 19, wherein the user interface action is selected from the group consisting of: creating, hiding, closing, minimizing, maximizing, normalizing, hiding, or moving a graphical window; reordering two or more graphical windows; keyboard input; creating, deleting or renaming a file; creating, deleting, renaming, or modifying a directory; changing a file attribute; changing a directory attribute; and executing, terminating, suspending, or deleting a process.
